(19) United States
(12) Patent Application Publication
(10) Pub. No.: US 2026/0050965 A1
(43) Pub. Date: Feb. 19, 2026

(54) SYSTEM

(71) Applicant: SOFTBANK GROUP CORP., Tokyo (JP)

(72) Inventor: Yusuke TAKADA, Tokyo (JP)

(73) Assignee: SOFTBANK GROUP CORP., Tokyo (JP)

(21) Appl. No.: 19/299,610

(22) Filed: Aug. 14, 2025

(30) Foreign Application Priority Data
Aug. 16, 2024 (JP) 2024-137256

(51) Int. Cl. G06Q 30/0601; G06Q 10/087

(52) U.S. Cl. CPC G06Q 30/06314; G06Q 10/08776

(57) ABSTRACT

A system includes a processor that is configured to receive user information, obtain store information, generate a recipe based on the user information and the store information, present the generated recipe to a user, and guide the user regarding the required ingredients for the recipe.

### CROSS-REFERENCE TO RELATED APPLICATION

This application is based on and claims priority under 35 USC 119 from Japanese Patent Application No. 2024-137256 filed on Aug. 16, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, food waste has become a significant social and economic problem. Supermarkets and grocery stores often experience surplus inventory and products that are close to their expiration dates, leading to increased disposal costs and environmental impact. Consumers, on the other hand, may have difficulty selecting meals that satisfy their preferences, dietary restrictions, and budgets while making efficient use of available store inventory. Moreover, there is a need for a system that can efficiently promote sales of overstocked or soon-to-expire items and suggest suitable complementary products, such as beverages and confectioneries, at the point of purchase.

### SUMMARY

To address these issues, the present invention provides a system including a processor that obtains user information and store information, generates recipes based on this information, and presents these recipes to users. The processor further guides users regarding the required ingredients for each recipe. Additionally, the processor identifies products that are close to their expiration dates and generates recipes that prioritize the use of these products. The processor is also configured to suggest plus-one items, including beverages and confectioneries, thereby promoting the sale of specific store items and reducing food waste.

“User information” means data related to the individual user, including but not limited to preferences, dietary restrictions, family structure, budget, and cooking experience. “Store information” means data regarding a retail location's inventory, including item names, quantities, prices, expiration dates, and product locations within the store.
“Recipe” means a set of instructions for preparing food, specifying ingredients, quantities, and preparation steps.
“Processor” means a hardware or software component capable of executing programmed instructions to perform data processing tasks within the system.
“Plus-one items” means additional products, such as beverages or confectioneries, which are suggested to complement the main products or recipes selected by the user.
“Ingredients” means the individual food items or materials required to prepare a specific recipe.
“Expiration date” means the date after which a store product is considered unsuitable or unsafe for sale or consumption.
“Generated recipe” means a recipe created by the system based on the combination of user information and store information.
“Required ingredients” means the specific ingredients needed to prepare the selected or generated recipe.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

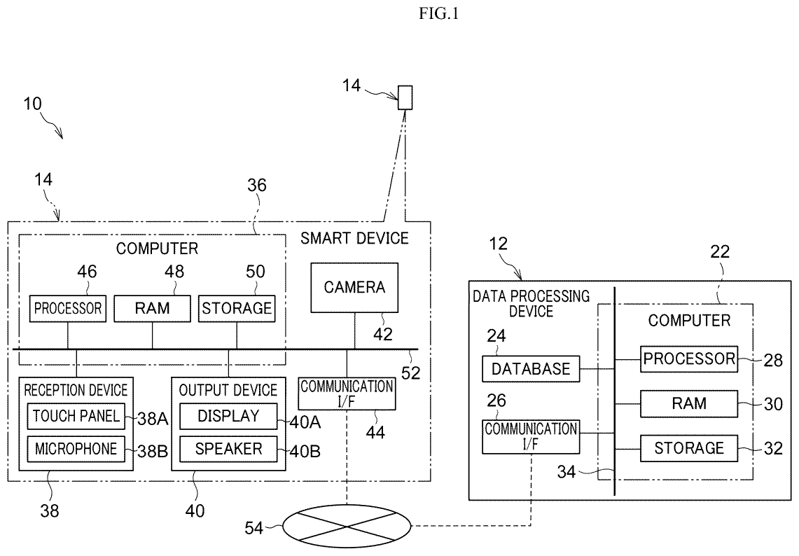

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

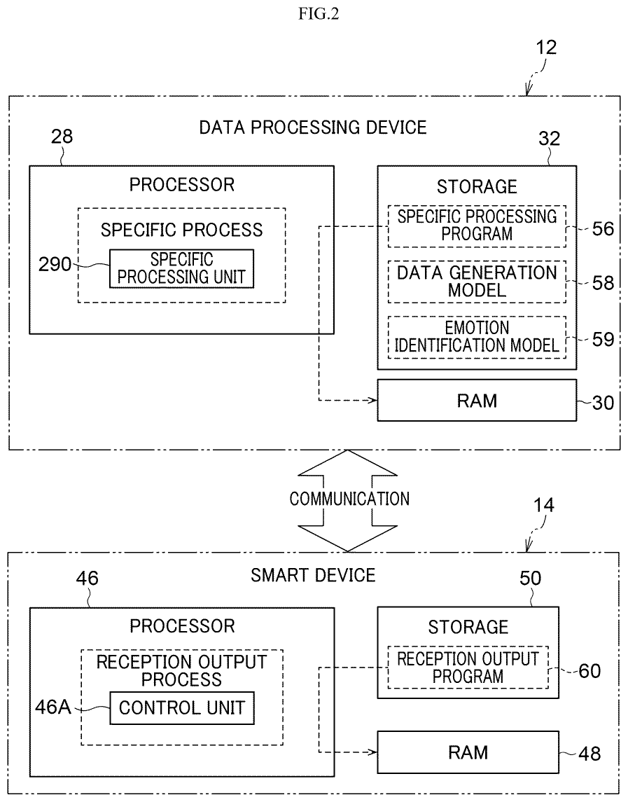

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In the modern food market, food loss due to expiration and unsold products has become a significant problem. Additionally, inventory management in stores has grown increasingly complex, and consumers often lack efficient means to acquire information tailored to their specific dietary needs, preferences, and health conditions. Furthermore, there is an unmet need for proposing recipes that make optimal use of available ingredients, particularly those nearing expiration or present in surplus, while simultaneously enhancing the consumer purchasing experience and reducing unnecessary waste.

The specific processing by the specific processing unit 290 of the data processing device 12 in Example 1 is realized by the following means.

The present invention provides a server including means for obtaining user attribute information, means for obtaining transaction facility attribute information, means for generating a prompt sentence based on said information and providing it to a generative artificial intelligence model, means for generating cooking method information via the generative artificial intelligence model, means for presenting the generated cooking method information to a user via a communication terminal device, means for presenting required component material information and component material location information, means for identifying component materials with approaching expiration or surplus inventory, and means for proposing supplementary product candidates based on the user's purchase history and preferences. This enables efficient reduction of food loss, optimization of inventory utilization, and enhancement of the user's shopping and cooking experience through personalized, AI-driven recommendations.

The term “user attribute information” refers to data relating to individual users, including but not limited to family composition, food preferences, budget constraints, cooking skill level, health conditions, and any other characteristic relevant to generating personalized recommendations.

The term “transaction facility attribute information” refers to data associated with a retail or distribution facility, including inventory data, product prices, expiration dates, stock levels, and information regarding promotional or highlighted products.

The term “prompt sentence” refers to a text input or instruction generated by the system, designed to elicit a specific response or output from a generative artificial intelligence model, based on user and facility attributes.

The term “generative artificial intelligence model” refers to an automated computational model or system that processes prompt sentences and produces output data, such as recipes or suggestions, using techniques of machine learning or artificial intelligence.

The term “cooking method information” refers to data describing instructions, procedures, or sequences for preparing and cooking food, which may include lists of ingredients, preparation steps, cooking times, and serving suggestions.

The term “communication terminal device” refers to any electronic device that enables the user to interact with the system, such as a smartphone, tablet, or other computing device capable of data communication.

The term “component material information” refers to data identifying ingredients or materials required for a recipe or culinary preparation, including quantities, product identifiers, and relevant nutritional attributes.

The term “component material location information” refers to data indicating the physical placement or in-store location of each required component material within a retail environment, such as aisle numbers, shelf positions, or department designations.

The term “storage period” refers to the time duration between the stocking of a component material and its expiration or best-before date, representing the remaining period the material is considered usable or sellable.

The term “surplus inventory” refers to a quantity of component materials or products held in stock that significantly exceeds expected or desired inventory levels within the transaction facility.

The term “supplementary product candidate” refers to an item recommended to complement a primary purchase, such as beverages or snacks, identified based on the user's past purchase history or stated preferences.

The term “purchase history information” refers to records of past acquisitions or transactions made by the user, including product types, purchase dates, quantities, and purchase frequencies.

The term “preference information” refers to data expressing the user's likes, dislikes, or tendencies regarding food, cooking, or shopping behaviors, which informs the generation of personalized recommendations.

An embodiment for implementing the invention will now be described in detail. The system is constructed using a combination of server, terminal, and database, and utilizes both standard computing hardware and software infrastructure. The server may be realized by general-purpose computing equipment such as cloud-based or on-premise server hardware. The terminal may be a mobile communication device, such as a smartphone or tablet. Communication between server and terminal is realized via network infrastructure, supporting secure communication protocols.

The server executes software processes written, for example, in Python using frameworks such as Django, operates a database management system such as PostgreSQL, and has access to a generative artificial intelligence model, for example, the GPT-3 model available via a cloud-based API platform. The terminal executes application software developed for either major mobile operating systems, for example, iOS or Android, using technologies such as React Native. The terminal and server communicate via RESTful APIs using HTTPS.

The user interacts with the terminal by launching the application and entering user attribute information, such as food preferences, allergy information, budget, family size, and cooking experience. The terminal presents graphical user interface forms to the user, validates the input, and converts it into JSON format before sending to the server.

The server receives this information and stores it within its user profile table in the database. At regular intervals, the server retrieves transaction facility attribute information, such as real-time inventory, product prices, and expiration data. This transaction facility information is obtained by the server from external sources or store management systems, often through scheduled API requests. The received facility information is parsed and stored in inventory-related tables within the database.

When generating a recipe, the server retrieves the current user profile and the relevant inventory information. The server builds a prompt sentence based on these data items, ensuring that the sentence communicates the user's needs and constraints as well as facility stock conditions to the generative artificial intelligence model. For example, the server may create a prompt such as:
“Generate a Japanese-style recipe for a user who likes Japanese food, has an egg allergy, and wants to use mackerel, Chinese cabbage, and tofu.”

This prompt sentence is transmitted to the generative artificial intelligence model over the network.

The generative artificial intelligence model, such as GPT-3 accessed via its public API, returns cooking method information—such as recipe title, list of required ingredients, preparation steps, and serving size. The server validates this information, stores it as a new recipe in the database, and prepares it for presentation.

The server issues a notification to the terminal using a service such as Firebase Cloud Messaging. The terminal receives the recipe proposal notification and displays it using a user interface alert. When the user opens the recipe, the terminal requests the cooking method information from the server. The server transmits cooking method information as well as component material information and component material location information, for example, ingredient lists and where those items are located in the store.

The terminal presents the cooking method information to the user, displaying step-by-step instructions and highlighting ingredient locations, such as aisle numbers or food sections, to facilitate efficient shopping.

In addition, the server periodically analyzes the inventory tables to identify component materials with approaching expiration or surplus status. When such materials are found, the server generates a new, specialized prompt sentence and initiates a new request to the generative artificial intelligence model. For example:
“Generate a recipe using discounted tofu and cabbage that can be prepared within 30 minutes and contains no eggs.”

This results in new recipe suggestions that help reduce food loss by utilizing perishable or surplus items.

Furthermore, the server analyzes the user's purchase history and preference information using machine learning models. When supplementary product candidates are identified—such as drinks or snacks that complement the user's typical purchases—the server sends proposal messages to the terminal, where these supplementary product candidates are displayed to the user and can be easily added to the shopping list.

Through this architecture utilizing a processor-based server, a networked database, terminal devices, generative artificial intelligence models, and prompt sentences tailored to user and facility context, the system enables highly personalized, efficient, and food-waste-reducing recipe and product recommendations. This enhances both the operational efficiency for facility operators and the experience for end users.

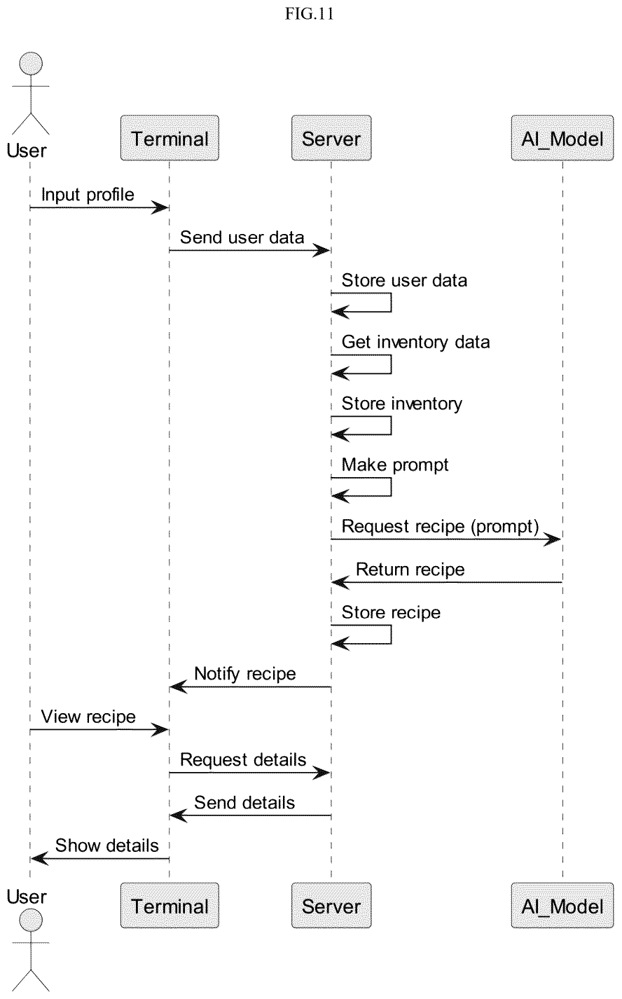

The following describes the processing flow using FIG. 11.

### Step 1:

User launches the application on the terminal and enters user attribute information such as family size, food preferences, budget, cooking experience, and health conditions via a graphical user interface.
Input: User's manual entries on the terminal's app interface.
Output: Structured user attribute data ready for transmission.
Terminal validates the entries, serializes them into a JSON format, and prepares them for secure transfer to the server.

### Step 2:

Terminal sends the serialized user attribute data to the server over HTTPS.
Input: JSON-formatted user attribute information.
Output: Confirmation of data receipt or error status.
Server receives the JSON, parses the information, validates the completeness and plausibility, and stores it as a new or updated user profile in the database.

### Step 3:

Server initiates a scheduled task to retrieve transaction facility attribute information from external sources or store systems (e.g., inventory, pricing, expiration dates, and promotions) by making periodic API requests.
Input: Automated API requests initiated by the server.
Output: Raw facility attribute data, typically as JSON or XML responses.
Server parses the incoming data, extracts relevant attributes, and updates or inserts records into the database's inventory-related tables.

### Step 4:

Server retrieves user attribute information and recent transaction facility attribute information from the database to initiate the recipe generation process.
Input: User profile data and latest facility inventory data from the database.
Output: Contextualized data set used for prompt creation.
Server constructs a prompt sentence that details the user's requirements and available inventory. For example: “Generate a Japanese-style recipe for a user who likes Japanese food, has an egg allergy, and wants to use mackerel, Chinese cabbage, and tofu.”

### Step 5:

Server sends the constructed prompt sentence to the generative AI model (e.g., via the OpenAI GPT-3 API) and receives as output a recipe containing a title, list of ingredients, preparation steps, and other relevant cooking method information.
Input: Prompt sentence based on user and facility attributes.
Output: AI-generated recipe information.
Server validates the AI output (e.g., ensuring no forbidden ingredients are present), stores the recipe details in the recipe database table, and marks the recipe for recommendation.

### Step 6:

Server prepares and sends a push notification to the terminal to inform the user of a newly generated recipe recommendation.
Input: Recipe metadata and user's device token.
Output: Notification payload transmitted to push notification service.
Terminal receives the notification and displays it to the user on the device's screen.

### Step 7:

User taps on the notification or opens the application to view the recipe details.
Input: User action on the terminal interface.
Output: Request from terminal to server for full recipe and ingredient location details.
Terminal requests recipe details from the server, and the server responds with the full cooking method information as well as component material and location information. Terminal displays these details in a structured and interactive interface.

### Step 8:

Terminal generates a digital shopping list for the user based on the selected recipe's ingredient list and corresponding store locations.
Input: Selected recipe data.
Output: Digital shopping list with product and location details.
User can view, manage, and mark off items from this shopping list while shopping.

### Step 9:

Server analyzes the inventory data to identify component materials with expiring storage periods or surplus inventory, using data aggregation and filtering algorithms.
Input: Inventory records including expiration and quantity data.
Output: List of prioritized materials.
Server constructs a new prompt for the generative AI model to create a recipe that makes use of these prioritized materials, and repeats the recipe generation process as in Step 5.

### Step 10:

Server analyzes the user's purchase history and preference information using a recommendation algorithm (e.g., collaborative filtering or machine learning models).
Input: Historic user purchase and profile data.
Output: List of supplementary product candidates identified for recommendation. Server sends product suggestion messages to the terminal for display.

### Step 11:

User reviews supplementary product candidates on the terminal and chooses whether to add any as extras to the shopping list.
Input: Displayed suggestions and user selection actions.
Output: Updated digital shopping list reflecting user's choices.
Terminal synchronizes the newly updated list with the server to ensure consistent records across devices.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional systems, it is difficult to provide optimal recommendations such as recipes or product proposals tailored to individual user preferences and real-time store conditions. Furthermore, such systems are insufficient in effectively utilizing products with short expiration dates or excessive inventory, which leads to increased food waste and inefficiency in sales promotion. Additionally, prior systems do not adequately consider users' emotional states, nor do they provide integrated in-store guidance to improve shopping efficiency. As a result, there is a need for a system that can generate personalized and context-aware recommendations by leveraging advanced artificial intelligence and emotion recognition, thereby reducing waste, promoting sales, and enhancing the overall user experience.

The specific processing by the specific processing unit 290 of the data processing device 12 in Application Example 1 is realized by the following means.

The present invention provides a server including a processor configured to acquire user attribute information, acquire point-of-sale attribute information, generate recommendation information based on the user attribute information and the point-of-sale attribute information, generate prompt sentences and generate the recommendation information using a generative artificial intelligence model, present the generated recommendation information to a display terminal, identify necessary goods from the recommendation information, provide arrangement information of the necessary goods to the display terminal, acquire user emotion information, specify a user emotional state using an emotion recognition model, and adjust the recommendation information according to the user emotional state. This enables the system to propose optimal, personalized recommendations in real time, reduce food waste through efficient inventory utilization, encourage sales, and provide emotionally considerate guidance to users, resulting in improved shopping efficiency and user satisfaction.

The term “user attribute information” refers to data representing characteristics or preferences of an individual user, including but not limited to family structure, food preferences, budget, cooking experience, health conditions, and other relevant personal information.

The term “point-of-sale attribute information” refers to data concerning the attributes of a sales location, such as inventory information, product prices, expiration dates, advertised products, and any other information related to the goods available at the sales location.

The term “recommendation information” refers to proposed content delivered to the user, including but not limited to recipes, product suggestions, shopping lists, promotional items, or guidance generated by the system based on user attribute information and point-of-sale attribute information.

The term “prompt sentence” refers to a formatted query or instruction generated for input to a generative artificial intelligence model, constructed from user attribute information and point-of-sale attribute information, to guide the generation of recommendation information.

The term “generative artificial intelligence model” refers to an artificial intelligence system, such as a large language model or similar technology, that is capable of generating natural language content or other recommendations in response to input data or prompt sentences.

The term “display terminal” refers to an electronic device, such as a smartphone, tablet, or computer, used by the user to display recommendation information, shopping lists, maps, notifications, or other communications from the system.

The term “necessary goods” refers to products or items identified from the recommendation information as required for the user's intended activities, such as ingredients for a recipe or items needed for purchase.

The term “arrangement information” refers to data that indicates the location, positioning, or in-store placement of necessary goods within the sales location, enabling efficient user navigation or collection.

The term “user emotion information” refers to data representing the current emotional state of the user, which may be acquired through biometric measurements, facial expressions, voice analysis, or other emotion recognition methods.

The term “emotion recognition model” refers to a computational model or algorithm that processes user emotion information to classify or determine the emotional state of the user.

The term “additional item” refers to a product proposed to the user, supplementary to the necessary goods, typically to enhance the user's experience or increase sales, such as beverages, snacks, or related commodities.

The term “advertisement-targeted item” refers to a product identified or promoted in conjunction with marketing campaigns or advertising efforts, and recommended to the user based on determined criteria by the system.

An embodiment of the invention will be described in detail below.

The system described herein is implemented using one or more server devices, user terminals such as smartphones or tablets, and at least one data storage device such as a database. The server includes a processor capable of executing software instructions for data processing, artificial intelligence, emotion recognition, and communication via network protocols. Software used for implementation can include programming frameworks such as Python (with Flask or FastAPI), Node.js, database management systems like PostgreSQL or MongoDB, and public APIs for communication and data retrieval. The generative artificial intelligence model can be instantiated using a large language model hosted via a machine learning platform such as a cloud-based service. The emotion recognition component can be implemented using existing emotion analysis APIs or local machine learning models.

The user uses a terminal such as a smartphone or tablet equipped with the system application. The user operates the terminal to input relevant information such as family size, food preferences, budget, cooking experience, health status, and so on. The terminal collects this user attribute information and transmits it in a secure fashion (for example, via HTTPS using REST API) to the server. The display of the terminal can be used to deliver instructions and output to the user, including product recommendations, shopping lists, and navigation within a sales location.

The server receives user attribute information, stores it in a database, and continuously or periodically receives updated point-of-sale attribute information from the sales location systems through appropriate API endpoints. This information includes inventory levels, specific item expiration dates, product prices, and campaign information about advertised goods and overstocked products.

The server retrieves both user attribute information and point-of-sale attribute information from the database and generates one or more prompt sentences. These prompt sentences are input to a generative artificial intelligence model for recipe or goods recommendation generation. For reference, an example of a prompt sentence is:
User Profile: 4 people in the family; prefers Japanese cuisine; budget 5000 yen; intermediate cooking experience; no health issues.
Store Inventory: Mackerel 10 units; Tofu 20 units; Chinese cabbage 13 units; Green onion 8 units; Soy sauce 15 units.

Please suggest an optimal recipe using the above information.

In another example, when the server identifies items with a short expiration date or excess inventory, the prompt sentence may be:
Please generate a recipe suitable for a family of 4, focusing on Japanese cuisine, using mackerel and tofu, which are nearing their expiration date.

When emotional data is used, as detected by the terminal (for instance, by analyzing facial expressions or voice samples), the server can generate a prompt sentence such as:
User Profile: 4 people in the family; prefers Japanese cuisine; budget 5000 yen; intermediate cooking experience; no health issues.
Store Inventory: Mackerel, Tofu, Chinese cabbage, Green onion, Soy sauce.

The user's current emotional state is high stress. Please generate an easy and comforting Japanese recipe using these ingredients to help reduce stress.

After transmitting the prompt sentence to the generative artificial intelligence model, the server receives recommendation information, such as a recipe and a corresponding list of necessary goods, from the AI model. The processor of the server analyzes and processes the returned data, converting it to an easy-to-use form for the user, and saves it in the database.

The server also identifies the required goods from the recommendation information, matches these to their arrangement information in the sales location (for example, aisle or section numbers), and generates a shopping list. This shopping list and the route or placement information are transmitted to the terminal.

The terminal displays the generated recommendation information, the list of necessary goods, and their arrangement information to the user, assisting in real-time navigation and efficient shopping. Additional item or advertisement-targeted item suggestions are presented to the user based on analyzed data including past purchase history and emotion information.

As an additional feature, the system may process purchase data and user feedback for further personalization of recommendations, and optimize the reduction of waste by prioritizing the use of items close to their expiration date or with excessive inventory. By integrating emotion recognition, the system further enhances user satisfaction by adjusting recommendation information in accordance with the detected emotional state.

This embodiment enables the implementation of a practical recommendation and guidance system adaptable to a wide variety of retail environments, by using commonly available hardware and software components, cloud-based artificial intelligence services, and emotion recognition technologies.

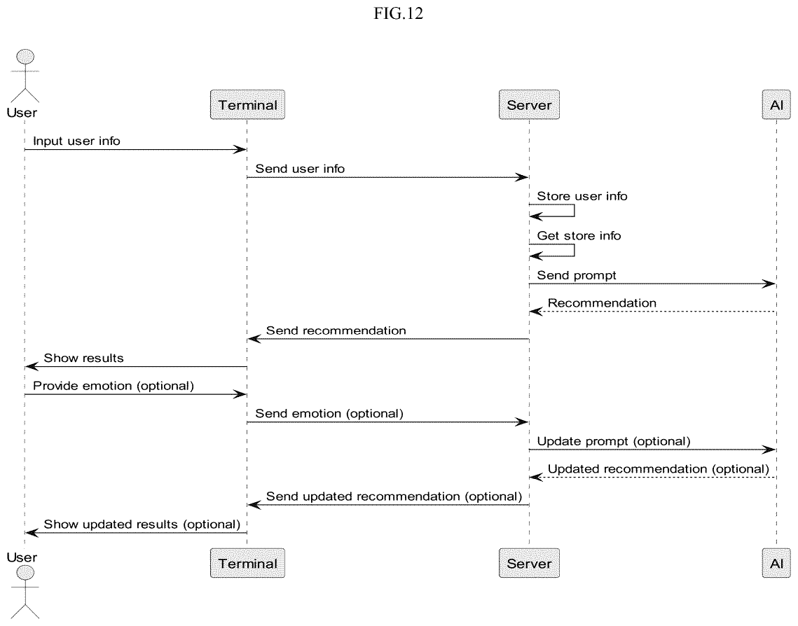

The following describes the processing flow using FIG. 12.

### Step 1:

The user operates the terminal and launches the application. The terminal prompts the user to input user attribute information such as family size, food preferences, budget, cooking experience, and health status.
Input: User's manual entry via the terminal's input interface.
Processing: The terminal collects and validates the user's input information and formats it as a structured data object, for example in JSON.
Output: Formatted user attribute information ready for transmission.

### Step 2:

The terminal transmits the user attribute information to the server via a secure network connection using a RESTful API.
Input: Formatted user attribute information from Step 1.
Processing: The terminal encrypts the data and sends it over the network to the server's API endpoint.
Output: Delivery of user attribute information to the server.

### Step 3:

The server receives the user attribute information and stores it in a database. The server also validates the data, checking required fields and data types.
Input: User attribute information received from the terminal.
Processing: The server parses the JSON data, performs validation checks, and saves the information to a user profile in the database.
Output: Updated or new user profile stored in the database.

### Step 4:

The server obtains point-of-sale attribute information by periodically calling APIs provided by retail systems or databases.
Input: None (scheduled or triggered server process).
Processing: The server requests data such as inventory levels, item expiration dates, prices, and promotional products from the retail systems. The server then standardizes data formats, cleans corrupted entries, and updates the point-of-sale attribute information in the database.
Output: Up-to-date point-of-sale attribute information stored in the database.

### Step 5:

The server retrieves both user attribute information and point-of-sale attribute information from the database in preparation for generating recommendation information.
Input: User profile and point-of-sale data from the database.
Processing: The server analyzes the data, identifies key parameters (such as product availability and user preferences), and creates a text prompt sentence for the generative AI model.
Output: Generated prompt sentence based on current user and point-of-sale conditions.

### Step 6:

The server sends the prompt sentence to the generative AI model via an API call.
Input: Prompt sentence generated in Step 5.
Processing: The server submits the prompt to the generative AI model, receives the response, and parses the generated recommendation, such as recipe details and a list of necessary goods.
Output: Recommendation information received from the generative AI model.

### Step 7:

The server processes the recommendation information, extracting the list of necessary goods and matching each with arrangement information (such as its location within the sales location).
Input: Recommendation information from Step 6 and arrangement data from the database.
Processing: The server cross-references items in the recommendation with store location data, compiles a detailed shopping list, and stores the results for the user session.
Output: Enriched recommendation information including product locations.

### Step 8:

The terminal receives the enriched recommendation information from the server and notifies the user with a display or push notification. The terminal presents details such as recipes, ingredient lists, and in-store navigation assistance.
Input: Enriched recommendation information from the server.
Processing: The terminal renders the information through the application's user interface, visually highlighting the suggested products and their locations.
Output: Visual presentation of personalized recommendations and shopping guidance to the user.

### Step 9:

The terminal collects optional emotion information from the user, such as facial expression or voice input, and transmits the processed data to the server.
Input: Biometric or audio data from the user, acquired by the terminal.
Processing: The terminal preprocesses the data, extracts emotion vectors or sentiment scores, and sends the information to the server.
Output: User emotion information delivered to the server.

### Step 10:

The server analyzes the emotion information using an emotion recognition model and may adjust subsequent recommendations to better match the user's current emotional state.
Input: User emotion information from Step 9.
Processing: The server classifies the user's emotional state (e.g., happy, stressed, tired) and, if necessary, modifies the prompt sentence or selection of recommendation information for the generative AI model and repeats relevant steps.
Output: Emotion-adapted recommendation information.

### Step 11:

The user interacts with the application, reviewing the proposed recommendations and shopping list, and confirms or modifies the selections as desired. The terminal records any updates and synchronizes the final list with the server.
Input: User actions via the terminal interface.
Processing: The terminal processes user feedback, updates the shopping list, and sends the confirmation to the server for storage and future personalization.
Output: Finalized and personalized shopping guidance based on user input.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In the modern consumer environment, there is a significant need to efficiently reduce food loss and to promote sales by providing optimized product and recipe suggestions that adapt to the diverse needs and emotional states of users. Existing systems do not sufficiently integrate real-time inventory data, user profiles, biological information, and proactive sales proposals into a single automated platform. As a result, these conventional systems fail to adequately address the dynamic nature of inventory usage and individual consumer motivation, nor do they provide context-sensitive recommendations that can both reduce waste and drive targeted sales.

The specific processing by the specific processing unit 290 of the data processing device 12 in Example 2 is realized by the following means.

The present invention provides a server including a processor configured to receive and store user information, acquire and store entity information via a communication network, generate and transmit a prompt sentence based on multiple conditions to a generative information processing model to obtain recipe information, provide recipe information to a terminal, extract and guide necessary items from the recipe information, analyze biological information, adjust recipe information according to the analysis, and propose additional candidate items based on purchase history or attribute information. This enables seamless integration of user data, inventory status, and emotional feedback, allowing for dynamic and personalized recipe generation and product proposals that address both food loss reduction and effective sales promotion.

The term “user information” refers to data relating to an individual who utilizes the system, including but not limited to preferences, demographic characteristics, purchase history, and personal dietary constraints.

The term “terminal” refers to an electronic device operated by the user for the purpose of data entry, information display, and communication with the server, such as a smartphone, tablet, or computer.

The term “entity information” refers to data pertaining to items available within a physical or virtual store, including inventory status, pricing, expiration dates, and promotional product details.

The term “communication network” refers to any digital infrastructure that enables the transmission of data between the terminal, server, and other external data sources.

The term “prompt sentence” refers to an automatically generated textual query or instruction that incorporates multiple contextual conditions, which is sent to a generative information processing model in order to receive tailored output.

The term “generative information processing model” refers to an artificial intelligence algorithm or computational method that receives input data, such as a prompt sentence, and produces context-dependent outputs, such as recipe suggestions.

The term “recipe information” refers to the content generated by the generative information processing model, including instructions, ingredient lists, and details necessary for preparing a specific dish or product.

The term “biological information” refers to data obtained from the user's physical or psychological state, including but not limited to emotional status, facial expressions, voice features, and other biometric signals.

The term “analysis result” refers to the outcome of evaluating biological information by the processor or an associated subsystem, which may be used to modify the system's behavioral outputs.

The term “additional candidate items” refers to supplementary products, such as beverages or snacks, proposed to the user based on purchase history, attribute information, or situational context.

The term “attribute information” refers to supplementary data associated with the user, including lifestyle, household structure, financial considerations, and other relevant personal characteristics.

The server, terminal, and user collaboratively operate to realize a system that reduces food loss and promotes sales by presenting dynamically generated and personalized recipes and product proposals.

The server comprises a processor, internal memory, external database (for example, using PostgreSQL or MySQL), application software developed in a programming language such as Python (using frameworks such as Flask or Django), and network communication capabilities. The server may be realized as a single physical computing device or as a distributed group of networked computers.

The terminal is represented by a user-operated device, such as a smartphone, tablet, or personal computer, capable of running an application for user input and information display. The application software may be an iOS or Android application built with native tools or cross-platform frameworks.

The user registers their personal data with the terminal application, which includes data such as dietary preferences, food allergies, budget, cooking skills, purchase history, and other attribute information. The user confirmation triggers the terminal to transmit the user information to the server via a secure communication network, such as the Internet, using HTTPS.

The server receives and stores the user information in the database. The server also regularly acquires entity information, such as inventory status, expiration dates, pricing, and campaign information, from one or more store management databases or inventory control systems using an API. Communication is handled via the communication network using libraries such as Python's requests. The retrieved entity information is parsed and stored in the database for later use in generating proposals.

To generate recipe information tailored to the user's needs and the current inventory, the server constructs a prompt sentence. This prompt sentence incorporates multivariate conditions, such as user information (e.g., “prefers Japanese food, has an egg allergy”) and entity information (e.g., “available ingredients: mackerel, Chinese cabbage, tofu”). The server transmits this prompt to a generative information processing model, for instance, a large language model such as GPT, via a suitable API.

Upon receipt of the prompt, the generative AI model returns recipe information that includes a list of ingredients, specific instructions, and optionally, preparation time and serving suggestions. The server records the generated recipe information, associates it with the user session, and prepares it for presentation to the terminal.

The terminal then displays the recipe information and the associated shopping guidance to the user. The application may also visually guide the user to product locations within the store or generate an actionable shopping list with checkboxes for user convenience.

Additionally, the terminal is equipped with hardware such as a camera and microphone to collect biological information, including facial expressions and voice data. With the user's consent, this information is collected and transmitted to the server. The server analyzes the received biological information using an emotion recognition engine, such as an emotion AI software platform or open-source machine learning (ML) libraries (e.g., OpenFace, Azure Face API), to determine the user's current psychological state (such as stress or happiness).

Using the emotion analysis result, the server may revise the prompt sentence to the generative AI model to generate recipes better suited to the user's current mood or psychological condition. For example, when the system detects user stress, the server may alter the prompt sentence accordingly to encourage selection of calming or easy-to-prepare recipes.

Furthermore, the server analyzes the entity information to identify products near their expiration or in surplus and can direct the generative AI model to create recipes that prioritize the use of such items.

The server is also configured to propose additional candidate items—such as beverages, desserts, or promotional products—by analyzing user purchase history, attribute information, current mood, and entity information.

The server transmits all proposed recipes and item suggestions to the terminal for presentation to the user, who can adjust their shopping list or make purchase selections through the application interface.

Example prompt sentences as used in this embodiment include:
“Generate a new recipe considering the user profile (likes Japanese food, has an egg allergy) and available stock (mackerel, Chinese cabbage, tofu).”
“Suggest a Japanese recipe that helps relieve stress for a stressed-out user.”
“Create a recipe using products that are near their expiration date (tofu, mackerel).”
“Generate a recipe that incorporates the manufacturer's new seasoning product.”

Through this integrated mechanism, the invention enables dynamic, context-aware recipe and product proposals by seamlessly combining user information, store inventory data, biological feedback, and advanced artificial intelligence technologies.

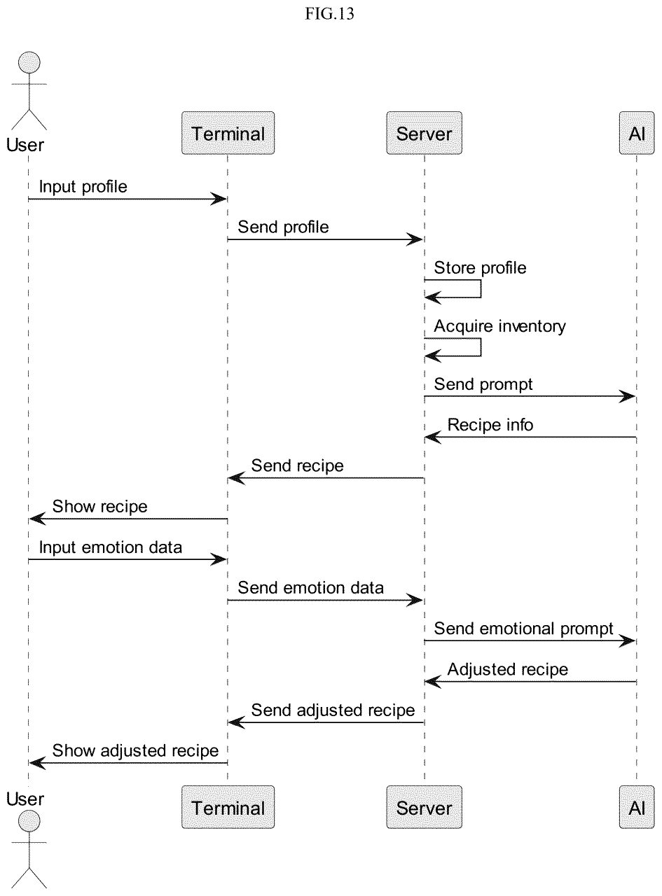

The following describes the processing flow using FIG. 13.

### Step 1:

User launches the terminal application and inputs personal information such as dietary preferences, food allergies, family size, budget, cooking skills, and purchase history into dedicated form fields. The input is structured as a user profile. The output is a completed user profile ready for transmission.

### Step 2:

Terminal transmits the completed user profile to the server using a secure communication protocol such as HTTPS. The input is the user profile data; the output is the successful delivery of user information to the server.

### Step 3:

Server receives the user profile and saves it into an internal database, using database management software such as PostgreSQL or MySQL. The input is the user profile JSON object, and the output is an updated user profile entry stored in the database.

### Step 4:

Server periodically acquires entity information from store inventory management systems through APIs. The input is API requests triggered by scheduled tasks; the output is the acquisition of inventory information, including product names, quantities, expiration dates, and prices.

### Step 5:

Server parses and standardizes the received entity information, extracting necessary fields and updating corresponding records in the database. The input is raw inventory data; the output is structured and updated entity records for later processing.

### Step 6:

Server constructs a prompt sentence by combining user profile conditions and current entity information, such as ingredient availability and allergy constraints. The input is user profile data and store entity data; data manipulation includes filtering, concatenation, and text formation to produce a context-sensitive prompt sentence. The output is a natural language prompt for the generative AI model.

### Step 7:

Server transmits the prompt sentence to the generative AI model via an API request and waits for a response. The input is the prepared prompt sentence; the output is generated recipe information including ingredients, cooking instructions, and preparation details.

### Step 8:

Server parses the recipe information returned by the generative AI model, saves it into the database, and prepares a formatted message for the terminal. The input is the AI-generated recipe; the output is a user-facing recipe package ready for transmission.

### Step 9:

Terminal receives the recipe package and displays it to the user. The input is the formatted recipe information from the server; the output is recipe details shown in the application, with options for the user to generate a shopping list or view related product locations in the store.

### Step 10:

Terminal captures biological information such as facial expressions and voice data using built-in cameras and microphones, with the user's consent. The input is real-time sensor data from the user; data processing involves collecting image and audio streams, which are packaged for delivery to the server. The output is a transmission of biological information.

### Step 11:

Server analyzes the biological information using an emotion recognition engine, such as an ML library or external API. The input is the raw or pre-processed biological data; the server processes it to determine the user's current emotional state. The output is an emotional status result, such as “stressed” or “happy”.

### Step 12:

Server determines whether the emotional status requires recipe adjustment. If needed, the server constructs a modified prompt sentence reflecting the user's emotions (e.g., “Suggest a relaxing recipe for a stressed user”), and, as in Steps 7-8, obtains a revised recipe from the generative AI model. The input is emotional status and existing recipe context; the output is an adjusted recipe better suited to the user's emotional state.

### Step 13:

Server examines entity information for items close to expiration or in surplus, and, if any are found, creates a prompt sentence prioritizing their use in new recipes. The input is entity information; the data processing includes filtering for expiration dates and stock levels, and the output is further recipe proposals designed to minimize waste.

### Step 14:

Server analyzes purchase history and user attributes to identify suitable additional items (plus-one products) to recommend alongside the recipe, such as beverages or desserts. The input is user purchase history and recipe context; the output is a proposal list of additional candidate items sent to the terminal.

### Step 15:

Terminal receives all recipe proposals and item recommendations, displays them to the user, and enables the user to add selected items to their shopping list or modify the selection before finalizing. The input is a combined package of recipes and product proposals from the server; the output is an updated shopping basket and user-confirmed selection for purchase.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional recipe recommendation systems generate suggestions primarily based on user preferences and health conditions. However, these systems do not incorporate real-time facility information, such as inventory and expiration dates, nor do they adapt to the user's emotional state detected from expressive input such as facial expressions or voice. As a result, user satisfaction is limited, opportunities for personalized engagement are missed, and food loss reduction or sales promotion at the facility side is insufficient. There is, therefore, a need for a system that can dynamically generate and present optimal cooking instructions by integrating user attribute information, real-time facility information, and user emotion data using advanced artificial intelligence models.

The specific processing by the specific processing unit 290 of the data processing device 12 in Application Example 2 is realized by the following means.

The present invention provides a server including: means for receiving user attribute information; means for acquiring real-time facility information; means for generating an input sentence for a generative artificial intelligence model utilizing natural language processing based on the user attribute information and facility information; means for generating a cooking instruction using the generative artificial intelligence model; means for presenting the generated cooking instruction and necessary item location and purchase support information to a user terminal; means for analyzing emotion data obtained from user expressive information through an emotion recognition module; means for readjusting the cooking instruction according to emotion data; and means for providing purchase support and facility navigation information to the user terminal. This enables the optimization of recipe suggestions tailored to personal circumstances and real-world constraints, improves user satisfaction, and facilitates reduction of food loss and promotion of item sales at the facility.

The term “user attribute information” refers to information related to characteristics of an individual user, including but not limited to demographic details, preferences, budget, cooking experience, health status, and family structure.

The term “facility information” refers to data associated with a commercial or retail facility, such as inventory status, item availability, pricing, expiration dates, and specific items being promoted, obtained in real time.

The term “generative artificial intelligence model” refers to a computerized model utilizing artificial intelligence and natural language processing to generate textual or structured output, such as recipes or cooking instructions, in response to a given input sentence.

The term “input sentence” refers to a text prompt or inquiry prepared for submission to a generative artificial intelligence model, which includes instructions, constraints, or requests for output generation.

The term “cooking instruction” refers to a set of step-by-step culinary directions, including an ingredients list and preparation methods, generated to assist a user in preparing a food item.

The term “user terminal” refers to an electronic communication device, such as a mobile device or computing apparatus, through which a user interacts with the system.

The term “item location information” refers to data indicating the specific placement or section of a facility where a required product can be found.

The term “purchase assistance information” refers to supplementary data or features provided to the user to facilitate the buying process, including recommended quantities, alternatives, or shopping lists.

The term “emotion data” refers to information extracted from user expressive input, such as facial expressions or voice data, indicative of the user's emotional state.

The term “emotion recognition module” refers to a software or hardware component configured to detect and analyze emotion data based on user expressive input.

The term “purchase history” refers to stored data relating to items previously bought or selected by the user.

The term “preference information” refers to recorded data reflecting user's expressed likes, dislikes, and habitual selections.

The term “related products” refers to supplementary or complementary goods, such as food, beverage, or other items, which may suit the user's needs or preferences in connection with a primary recommendation.

The term “purchase support information” refers to data, notifications, or functionalities that aid the user's planning, selection, or acquisition of items, including lists, reminders, or guidance.

The term “facility navigation information” refers to guidance or route data that assists the user in moving within a facility to the locations of required items.

One embodiment of the present invention provides a system for dynamically generating and delivering personalized cooking instructions by integrating user attribute information, facility information, and user emotion data through the use of a generative artificial intelligence model.

The system comprises a server, a user terminal such as a smartphone, and a database. The user terminal is equipped with an application that allows the user to interact with the system and input relevant information. The server is realized by a general-purpose computer or cloud-based platform equipped with software for data collection, data processing, artificial intelligence modeling, and communication. The database may be implemented using relational database management systems such as MySQL or PostgreSQL.

The user utilizes the user terminal, which may be a mobile device running iOS or Android, to open the application. The application presents a user interface for inputting user attribute information such as family size, food preferences, budget, cooking experience, health status, and other relevant characteristics. Once the information is input, the terminal transmits the data via encrypted communication (HTTPS) to the server.

The server executes software that stores the received user attribute information in the database. In parallel, the server periodically accesses the facility information, such as inventory status, product availability, pricing, and expiration dates, by making API calls to facility data sources. For instance, inventory and product data can be obtained from the store management system in a structured format such as JSON.

The server retrieves both the user attribute information and the latest facility information from the database. The server then generates a prompt sentence as textual input to a generative artificial intelligence model. This prompt is constructed to reflect the user's preferences, restrictions, current emotional state, and real-time facility conditions. The generative artificial intelligence model, which may be implemented by using commercially available AI models such as a large language model accessible by API (for example, a neural network-based model deployed on a cloud service), processes the prompt and returns a cooking instruction including ingredients and preparation steps.

The server stores the generated cooking instruction in the database and transmits the content to the user terminal for display. The user terminal, upon receiving the cooking instruction, provides a list of necessary items and their location information within the facility, as well as purchase support information such as estimated quantities and alternatives.

The user terminal may further request the user's permission to access the built-in camera and microphone to collect expressive input, such as facial expression or voice data. The collected data is securely transferred to the server, which processes it with an emotion recognition module implemented in software, such as a machine learning-based emotion classifier running on the server. Emotion data is analyzed and stored in the database. Based on the identified emotional state, the server can re-generate or adjust the cooking instruction by constructing a revised prompt sentence reflecting the emotion results and again querying the generative artificial intelligence model.

In a particular example, the user prefers Japanese cuisine and is sensitive to certain ingredients. Facility information indicates high stock of fresh mackerel and cabbage. The user is detected as feeling stressed, based on a brief facial expression analysis by the terminal. The server constructs a prompt sentence as follows:

### User Profile:

Likes Japanese food
Egg allergy
Recently stressed

### Store Inventory:

Fresh mackerel
Cabbage abundant
Tofu low stock

### Recipe Generation Conditions:

Must be Japanese cuisine
Must help reduce stress
Should be easy to cook
Avoid eggs

Generate a recipe and a corresponding shopping list.

The generative artificial intelligence model processes the prompt and returns, for example, a suggestion for “Mackerel and Cabbage Nimono” with ingredient lists and preparation steps. The terminal then displays this information and provides in-app navigation to the appropriate sections of the facility where the necessary items are located.

The server may also monitor the facility inventory for items near expiration or in excess supply, prioritize those items in the generative process, and provide additional suggestions to the user terminal, thus contributing to food loss reduction and sales promotion.

In this way, the server, user terminal, and database work together to deliver a detailed, responsive, and context-aware cooking instruction system using a generative artificial intelligence model and prompt sentence construction. The system operates using typical hardware and software components as described, and may be implemented using standard development tools for mobile and server applications, database management systems, and commercially available or custom artificial intelligence solutions.

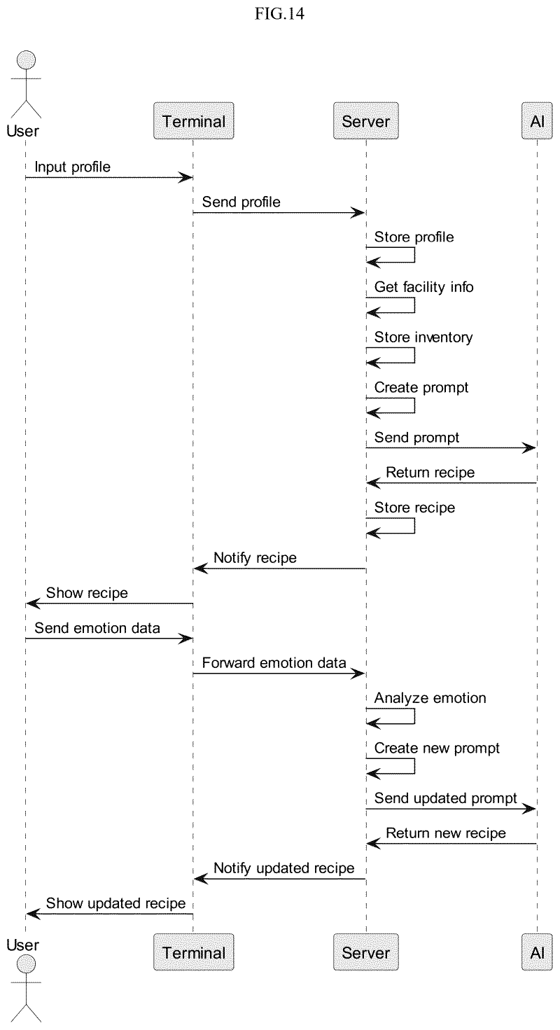

The following describes the processing flow using FIG. 14.

### Step 1:

User launches the mobile application on the terminal and enters user attribute information such as food preferences, allergy information, family structure, budget, and cooking experience into input forms.
Input: Manually entered user data via the mobile application interface.
Output: Structured user attribute data displayed for user confirmation, transmitted to the server upon submission.
Specific Action: User taps submit, and terminal sends a JSON-formatted user profile to the server.

### Step 2:

Server receives user attribute information from the terminal and stores the data in the database.
Input: JSON-formatted user attribute data.
Output: User profile is stored in a designated table within the structured database. Specific Action: Server parses the received data and updates or creates user records in the storage system.

### Step 3:

Server periodically requests facility information such as inventory status, pricing, and product expiration dates from an external system via API.
Input: Scheduled API call (e.g., REST request) to the facility management service.
Output: JSON or XML-formatted facility information including item availability, stock levels, and expiration status.
Specific Action: Server handles API responses and updates inventory-related tables in the database.

### Step 4:

Server retrieves both the stored user profile and the latest facility information to prepare a prompt sentence for the generative AI model.
Input: User attribute data and current facility inventory data from the database.
Output: A textual prompt sentence reflecting user needs, preferences, and inventory context.
Specific Action: Server programmatically constructs a prompt such as, “Generate a Japanese recipe for a user with an egg allergy and high stress, using fresh mackerel and abundant cabbage. Recipe should be simple and avoid eggs.”

### Step 5:

Server sends the constructed prompt sentence to the generative AI model using a secure API call and receives a generated cooking instruction.
Input: Textual prompt sentence.
Output: Textual cooking instruction including a recipe, list of ingredients, and step-by-step preparation guide.
Specific Action: Server communicates with the generative AI model endpoint, receives the recipe content, and parses it for storage.

### Step 6:

Server saves the received cooking instruction to the database and informs the user terminal of the update.
Input: Generated cooking instruction from the AI model.
Output: Update to the recipes table in the database and an event notification for the terminal.
Specific Action: Server issues insertion or update queries in the database and triggers a push notification to the terminal.

### Step 7:

Terminal downloads and displays the latest cooking instruction to the user, presenting the ingredient list, preparation steps, and additional purchase support such as item location within the facility.
Input: Push notification and recipe data from the server.
Output: User-facing display of the recipe, shopping list, and route information for in-facility navigation.
Specific Action: Terminal renders the full recipe page, shows ingredient checklists, and launches a map interface for the in-facility shopping route.

### Step 8:

Terminal prompts the user for permission to capture expressive input using the built-in camera or microphone, collects facial expression or voice data, and sends this data to the server for emotion analysis.
Input: User's expressive video or audio data.
Output: Encrypted emotion data transmitted to the server.
Specific Action: Application requests permission, records a brief video or voice sample, and sends the recording securely via HTTPS.

### Step 9:

Server receives the expressive input and analyzes it using an emotion recognition module implemented in software (e.g., a machine learning model).
Input: Video or audio data from the terminal.
Output: Detected emotion status, such as “stressed,” “happy,” or “neutral,” stored in the database.
Specific Action: Server applies the emotion recognition process, categorizes the emotion, and attaches the result to the user profile data.

### Step 10:

Server determines whether the user's emotion state suggests recipe adjustment, constructs a new prompt sentence reflecting the emotion, and queries the generative AI model for an updated recipe.
Input: Detected user emotion and current recipe information.
Output: Modified or newly generated cooking instruction based on the user's emotional state.
Specific Action: Server generates and sends a new prompt like, “User is feeling stressed. Suggest comfort food from available facility inventory,” and receives an emotion-adapted recipe.

### Step 11:

Terminal updates the display to show the adjusted recipe and notifies the user about the revised cooking suggestion.
Input: Updated recipe content from the server.
Output: Recipe screen on the terminal reflects the updated, emotion-optimized instruction.
Specific Action: Terminal provides an on-screen notification such as “A recipe tailored to your mood is now available.”

### Step 12:

Server monitors facility inventory for products nearing expiration or in excess, constructs special prompt sentences for the generative AI model to create recipes that promote the use of such items.
Input: Current facility inventory status.
Output: Special cooking instructions featuring prioritized items, stored in the database and sent to the terminal for display as additional suggestions.
Specific Action: Server automatically identifies qualifying products and triggers the generation and dissemination of food loss reduction recipes.

### Step 13:

Server analyzes user purchase history, preferences, and emotion data to identify relevant supplementary items, and sends recommendations for related products to the terminal.
Input: Historical purchase records, preference profiles, and emotion status.
Output: A list of supplementary or related items for cross-selling, sent to the terminal.
Specific Action: Server generates suggestions and pushes them through the API, while the terminal presents these options as add-ons for the current shopping session.

### Step 14:

User selects desired related products or ignores the suggestions, updating the purchase plan as needed within the terminal.
Input: Interactive user selection of add-on suggestions.
Output: Revised shopping list and purchase intention stored locally and communicated to the server.
Specific Action: User taps “Add” or “Ignore” for suggested items, and the shopping list is updated accordingly.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

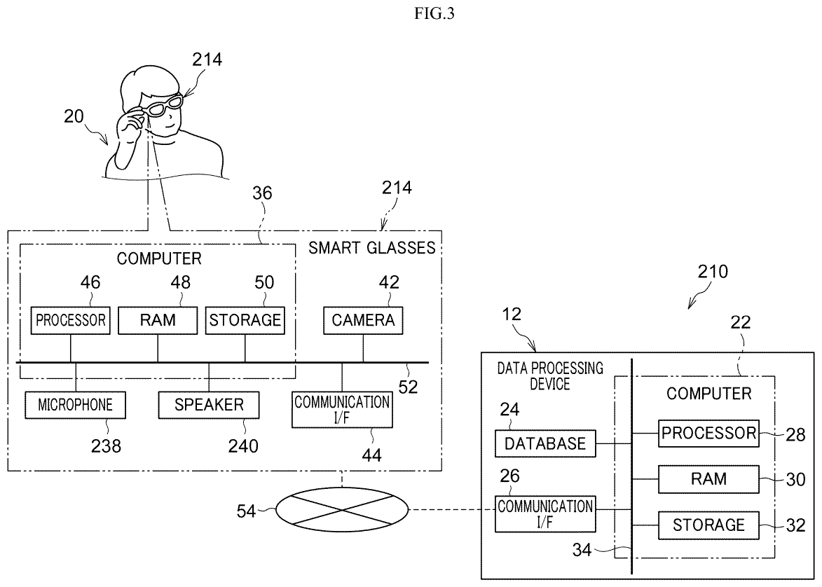

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

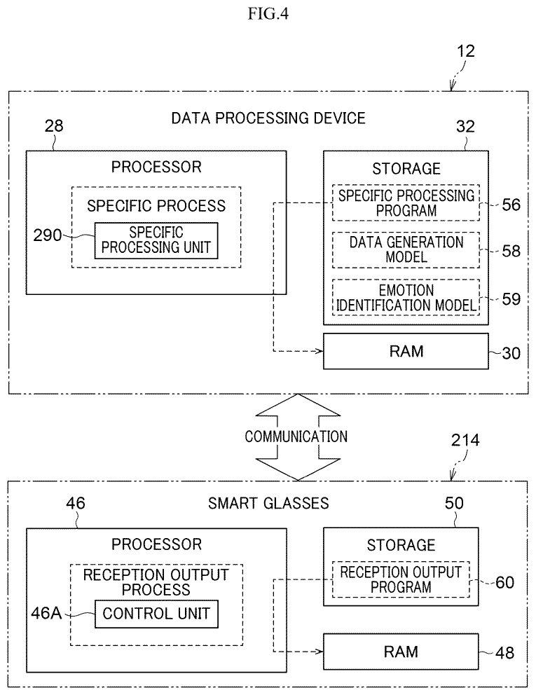

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

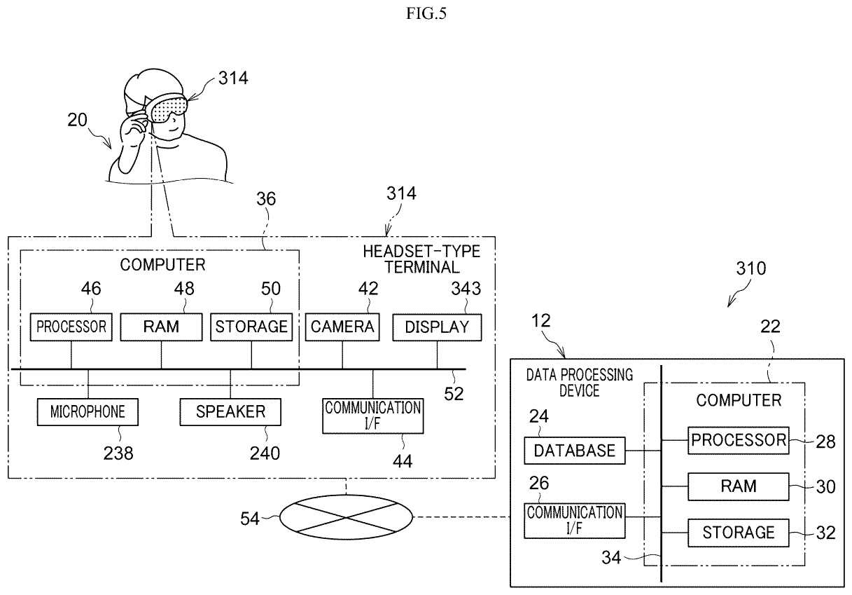

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

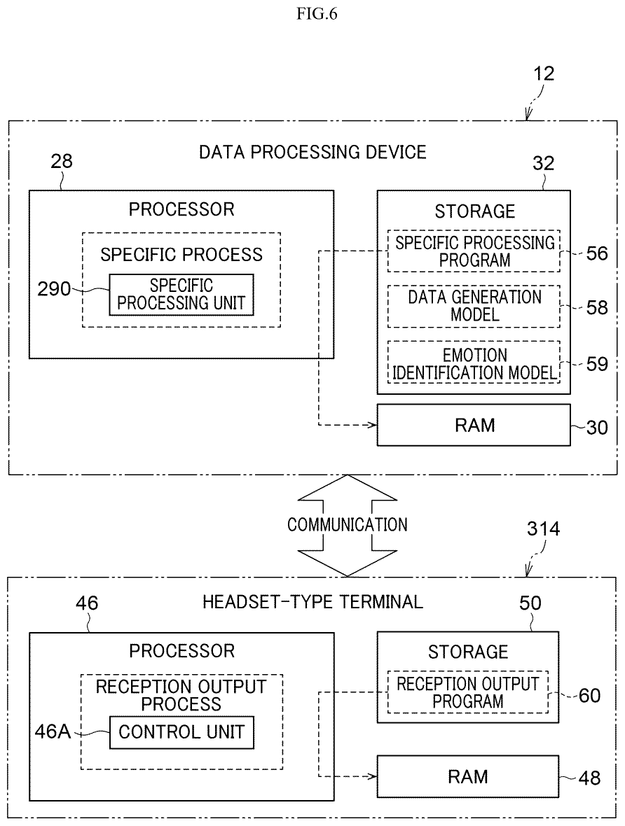

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

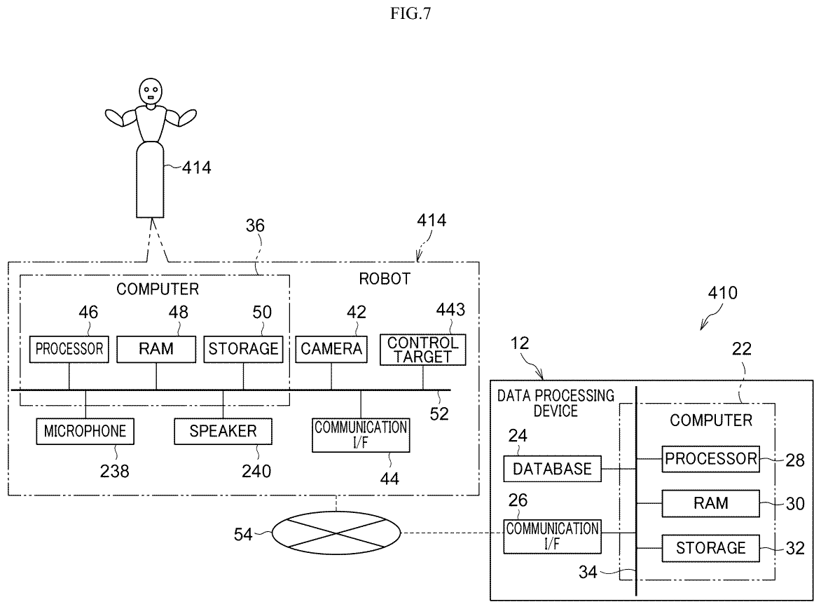

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

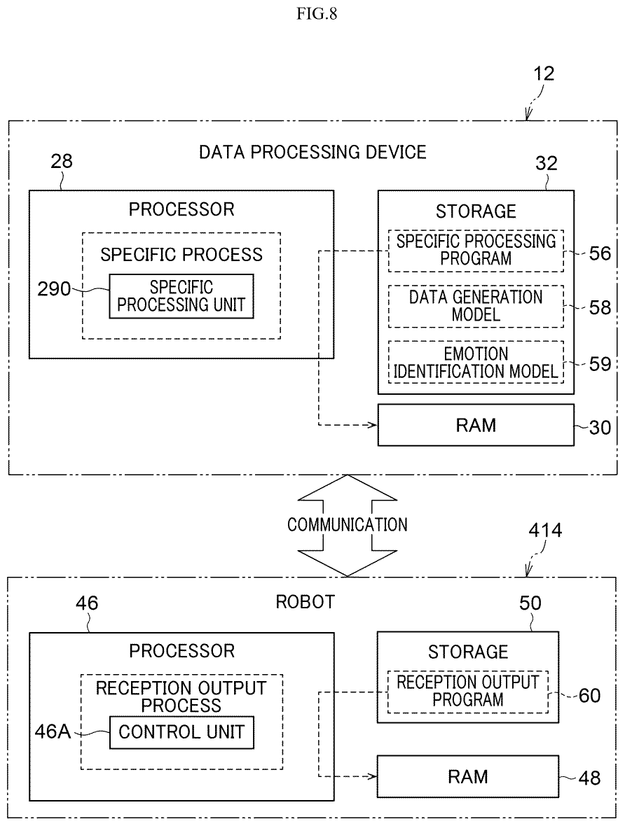

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

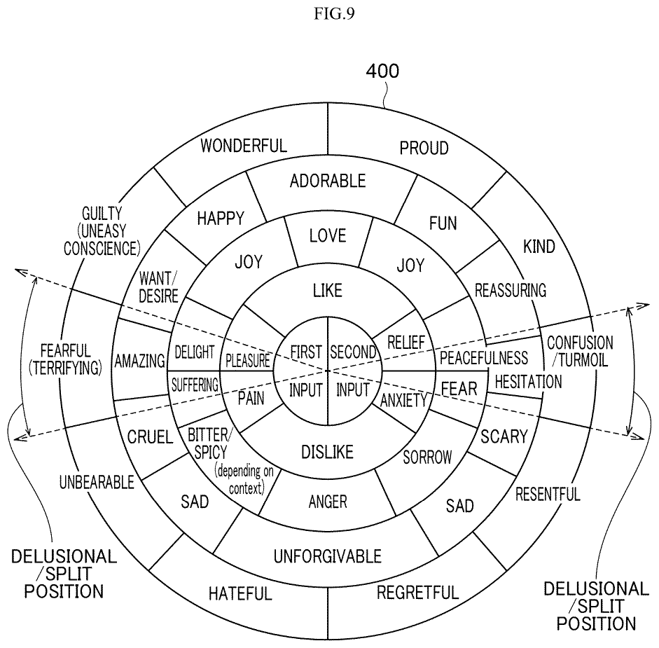

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

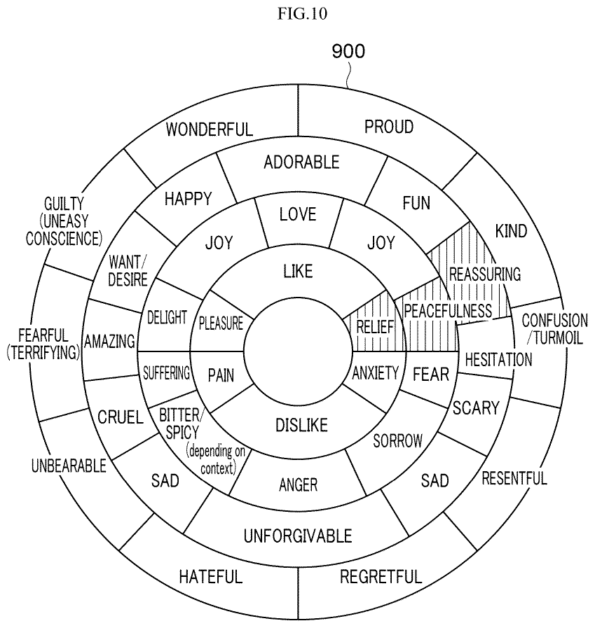

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system including a processor,
wherein the processor is configured to
obtain user attribute information,
obtain transaction facility attribute information,
generate, based on the user attribute information and the transaction facility attribute information, a prompt sentence for a generative artificial intelligence model,
generate cooking method information by providing the prompt sentence to the generative artificial intelligence model,
present the generated cooking method information to a user via a communication terminal device,
and present required component material information and component material location information based on the cooking method information.

### (Supplementary 2)

The system according to supplementary 1,
wherein the processor is configured to
identify component materials whose storage period is approaching or that are in surplus inventory,
regenerate cooking method information that preferentially includes the identified component materials, and
present the regenerated cooking method information to the user via the communication terminal device.

### (Supplementary 3)

The system according to supplementary 1,
wherein the processor is configured to
identify supplementary product candidates based on the user's purchase history information and preference information, and
propose the identified supplementary product candidates to the user.

### Application Example 1

### (Supplementary 1)

A system including a processor,
wherein the processor is configured to
acquire user attribute information,
acquire point-of-sale attribute information,
generate recommendation information based on the user attribute information and the point-of-sale attribute information,
generate a prompt sentence and generate the recommendation information using a generative artificial intelligence model,
present the generated recommendation information to a display terminal,
identify necessary goods from the recommendation information and present them to the display terminal,
provide arrangement information of the necessary goods to the display terminal,
acquire user emotion information, specify a user emotional state using an emotion recognition model, and adjust the recommendation information according to the user emotional state.

### (Supplementary 2)

The system according to supplementary 1,
wherein the processor is configured to
identify products with short expiration dates or products with excessive inventory from the point-of-sale attribute information, and generate recommendation information that prioritizes such products.

### (Supplementary 3)

The system according to supplementary 1,
wherein the processor is configured to
specify additional items or advertisement-targeted items based on the user attribute information, past purchase history, and emotion information, and present such items as recommendation information to the display terminal.

### Example 2

### (Supplementary 1)

A system including a processor,
wherein the processor is configured to
receive and store user information from a terminal for acquiring information,
acquire and store entity information via a communication network,
generate a prompt sentence including a plurality of conditions based on the user information and the entity information, and transmit the prompt sentence to a generative information processing model to obtain recipe information,
provide the obtained recipe information to the terminal,
extract and guide necessary items from the recipe information,
analyze biological information acquired from the terminal, and adjust the recipe information according to the analysis result, and
specify and propose additional candidate items based on user purchase history information or attribute information.

### (Supplementary 2)

The system according to supplementary 1,
wherein the processor is configured to extract information relating to expiration dates from the stored entity information, and generate recipe information that preferentially uses corresponding items.

### (Supplementary 3)

The system according to supplementary 1,
wherein the processor is configured to present additional candidate items based on the user information, purchase history information, biological information, and entity information.

### Application Example 2

### (Supplementary 1)

A system including a processor,
wherein the processor is configured to
receive user attribute information through an information processing means;
acquire facility information through an information processing means;
generate, based on the user attribute information and the facility information, an input sentence for a generative artificial intelligence model utilizing natural language processing, and generate a cooking instruction using the generative artificial intelligence model;
present the generated cooking instruction to a user terminal;
present, from the cooking instruction, necessary item location information and purchase assistance information to the user terminal;
analyze emotion data based on user expressive information through an emotion recognition module;
re-adjust the cooking instruction according to the analyzed emotion data; and
provide purchase support information and facility navigation information based on the cooking instruction.

### (Supplementary 2)

The system according to supplementary 1,
wherein the processor is configured to identify items with imminent expiration or excessive stock, and generate a cooking instruction using the identified items.

### (Supplementary 3)

The system according to supplementary 1,
wherein the processor is configured to present suggestion information regarding related products based on purchase history, preference information, or emotion data.

What is claimed is:

1. A system comprising a processor,
wherein the processor is configured to:
receive user information,
obtain store information,
generate a recipe based on the user information and the store information,
present the generated recipe to a user, and
guide the user regarding the required ingredients for the recipe.

2. The system according to claim 1, wherein the processor is further configured to identify products with expiration dates approaching and generate recipes that prioritize the use of the identified products.

3. The system according to claim 1, wherein the processor is further configured to suggest plus-one items, including beverages or confectioneries.
